(19) United States
(12) Patent Application Publication
(10) Pub. No.: US 2022/0341665 A1
(43) Pub. Date: Oct. 27, 2022

(54) SEPARATING DEVICE, TREATMENT SYSTEM, METHOD FOR SEPARATING TWO SPATIAL REGIONS, AND METHOD FOR TREATING WORKPIECES

(71) Applicant: Dürr Systems AG, Bietigheim-Bissingen (DE)

(72) Inventors: Oliver Iglauer-Angrik, Stuttgart (DE); Kevin Woll, Heilbronn (DE)

(73) Assignee: Dürr Systems AG, Bietigheim-Bissingen (DE)

(21) Appl. No.: 17/639,928

(22) PCT Filed: Sep. 4, 2020
(86) PCT No.: PCT/DE2020/100773

§ 371 Date: Mar. 3, 2022

(30) Foreign Application Priority Data
Sep. 4, 2019 (DE) 10 2019 213 430.0

(51) Int. Cl. F26B 25/00; F26B 21/00; F26B 15/18; F24F 9/00

(52) U.S. Cl. CPC F26B 25/008; F26B 21/004; F26B 15/18; F24F 9/00; F26B 2210/12; F24F 2009/002

(57) ABSTRACT

In order to provide a separating device for separating two spatial regions, which has a simple structure and provides for efficient fluid separation, it is proposed that the separating device comprises a supply device for supplying a separating fluid to be introduced between the two spatial regions, the supply device preferably comprising at least two guide elements for guiding the separating fluid, which guide elements are designed in particular as guide plates

### RELATED APPLICATION

This application is a national Phase of international application No. PCT/DE2020/100773 filed on Sep. 4, 2020, and claims the benefit of German application No. 10 2019 213 430.0 filed on Sep. 4, 2019, which are incorporated herein by reference in their entirety and for all purposes.

### FIELD OF DISCLOSURE

The present invention relates to a separating device for separating two spatial regions, for example two treatment space portions of a treatment space of a treatment system.

### BACKGROUND

For example, locks can be provided at an entrance to or exit from a treatment space of a treatment system for treating workpieces in order to provide for efficient separation of a fluid, in particular air, arranged inside the treatment space from ambient air surrounding the treatment system. In particular, undesired exchange of air can be minimized or prevented, as a result of which, for example, energy expenditure for conditioning the fluid arranged in the treatment space, in particular for conditioning air, can be minimized.

Such locks can, for example, provide for efficient fluid separation by producing flow rollers, but usually require a relatively large amount of installation space.

### SUMMARY OF THE INVENTION

The problem addressed by the present invention is that of providing a separating device which has a simple structure and provides for efficient fluid separation.

According to the invention, this problem is solved by the separating device according to claim 1.

The separating device is preferably a separating device for separating two spatial regions.

The separating device preferably comprises a supply device for supplying a separating fluid to be introduced between the two spatial regions.

The supply device preferably comprises one or more guide elements, in particular at least two guide elements, for guiding the separating fluid.

The one or more guide elements, in particular all of the guide elements, are preferably designed and/or arranged so as to be rigid and/or immovable.

It may be favorable for one or more guide elements, in particular the at least two guide elements, to be designed as guide plates.

In one embodiment of the invention, several or all of the guide elements, in particular the at least two guide elements, can be arranged at least approximately in parallel with one another.

Alternatively or additionally, one or more or all of the guide elements can be arranged at least approximately vertically.

In particular, one or more or all of the guide elements, in particular the at least two guide elements, can together form an angle of at most approximately 10°, in particular at most approximately 5°, preferably at most approximately 2°.

Alternatively or additionally, at least one guide element, at least two guide elements or all of the guide elements can be inclined by at most approximately 10°, preferably at most approximately 5°, for example at most approximately 2°, relative to the direction of gravity.

The separating fluid is in particular air, for example conditioned and/or cleaned air and/or ambient air and/or hall air.

The separating device preferably provides for fluid separation of the two spatial regions, which means that the fluids arranged in the respective spatial regions are not mixed with one another, or are only mixed with one another slightly, across the spaces.

The separating device is used in particular to reduce or prevent fluid exchange between the fluids arranged in the two spatial regions.

The separating device can preferably be used to prevent hotter air from one of the spatial regions from being mixed with colder air from the other of the two spatial regions.

One or more or all of the guide elements preferably extend downward, starting from a ceiling region of one of the spatial regions or of both spatial regions.

In particular, one or more or all of the guide elements can be arranged, in particular fixed, on a ceiling of one or both spatial regions and can extend downward starting from this ceiling.

A ceiling is in particular a wall delimiting a spatial region or the two spatial regions at the top.

One or more or all of the guide elements can extend over at least approximately 70%, preferably at least approximately 90%, of a width of a passage opening interconnecting the two spatial regions.

In particular, one or more or all of the guide elements can extend in the horizontal direction over the entire width of the passage opening interconnecting the two spatial regions.

By supplying the separating fluid, a separating fluid curtain, in particular an air curtain, can preferably be produced, which curtain preferably extends over at least approximately 70%, for example at least approximately 90%, of a width of a passage opening interconnecting the two spatial regions. The separating fluid curtain, in particular the air curtain, preferably extends over the entire width of the passage opening interconnecting the two spatial regions.

It may be favorable for one or more or all of the guide elements to comprise metal plates or to be formed from metal plates.

One or more or all of the guide elements are preferably planar and/or flat.

It may be favorable for one or more or all of the guide elements to have an extent in two main directions of extension at least 100 times, preferably at least 500 times, the extent thereof in the thickness direction, which is perpendicular to the two main directions of extension.

A distance between two guide elements is preferably at most approximately 20 times, for example at most approximately 10 times, a material thickness of one or both guide elements.

For example, a distance between the two guide elements can be at most approximately 5 cm, for example at most approximately 2 cm.

It may be advantageous for at least two guide elements to be interconnected, for example by means of connecting pieces which extend in particular in parallel with a main flow direction of the separating fluid in the region between the at least two guide elements.

In one embodiment of the invention, one or more or all of the guide elements can extend, at least in portions, over at least approximately 5%, for example at least approximately 10%, preferably at least approximately 20%, of a maximum or average height of a passage opening interconnecting the two spatial regions.

In one embodiment of the invention, at least approximately 50%, preferably at least approximately 80%, for example at least approximately 90%, in particular 100%, of a volume flow of the separating fluid to be introduced between the two spatial regions can be introduced between the two spatial regions between the guide elements, in particular between the two guide elements.

In particular, the separating fluid can be introduced between the two spatial regions only between the two guide elements.

The supply device thus preferably comprises no other supply opening for supplying separating fluid than the supply opening which is formed on an end region of said supply device that is formed by the at least two guide elements.

The at least two guide elements form in particular a single and/or continuous slotted nozzle for supplying the separating fluid between the two spatial regions.

The separating device can comprise a blocking device for blocking the separating fluid.

The blocking device preferably comprises one or more blocking elements which prevent or at least reduce the spreading of a separating fluid flow into at least one of the two spatial regions.

One or more blocking elements are preferably arranged in a floor region of the separating device, for example arranged and/or fixed on a floor of one or both spatial regions.

One or more or all of the blocking elements are preferably designed as deflector elements, in particular deflector plates.

It may be favorable for one or more or all of the blocking elements to extend upward, starting from the floor region, in particular starting from the floor, in particular at least approximately vertically upward.

It may be favorable for one or more or all of the blocking elements of the blocking device to be offset in the parallel direction from a separating plane along which the two spatial regions can be separated by means of the separating device.

The separating plane extends in particular between the two guide elements.

The separating plane is preferably a plane of symmetry, in particular a mirror plane, of the two guide elements.

It may be favorable for the separating plane to be arranged substantially vertically; the separating plane preferably forms a central plane of a supply slot of the supply device for supplying the separating fluid between the two spatial regions.

It may be favorable for the separating device to comprise a discharge device for discharging the separating fluid.

The discharge device is arranged in particular in a floor region of the separating device, for example integrated in a floor of one or both spatial regions.

The discharge device preferably comprises one or more suction slots which are arranged in particular partially or at least approximately completely in parallel with the separating plane of the separating device.

It may be favorable for one or more or all of the suction slots to extend along one or more planes which are offset in the parallel direction from the separating plane.

One or more or all of the suction slots are preferably arranged and/or formed continuously along the relevant plane or are arranged and/or formed in multiple parts and discontinuously.

It may be advantageous for the discharge device, in particular an outlet opening, for example a suction slot, and one or more blocking elements of a blocking device of the separating device to be arranged on opposite sides of a separating plane of the separating device.

The one or more or all of the blocking elements of the blocking device are preferably offset relative to the separating plane, in particular starting from the separating plane, toward one of the spatial regions, whereas one or more or all of the outlet openings, in particular suction slots, are preferably offset relative to the separating plane, in particular starting from the separating plane, toward the other of the two spatial regions.

Such an arrangement can make it possible, in particular, for a separating fluid curtain to extend downward substantially along the separating plane from the one or more guide elements and extracted by suction in a floor region of the separating device on one side, with simultaneous prevention or at least reduction of flow spreading to the other side by means of the one or more blocking elements.

In this way, in particular, a particularly space-saving and flow-efficient separation of the two spatial regions is made possible.

The separating device is particularly suitable for use in a treatment system for treating workpieces.

The present invention therefore also relates to a treatment system for treating workpieces, in particular a drying system for drying coated vehicle bodies.

The treatment system preferably comprises the following:

a treatment space for treating workpieces, which comprises one or more treatment space portions;

at least one separating device for separating two spatial regions, in particular a separating device according to the invention, wherein at least one treatment space portion forms one of the spatial regions which can be separated from another of the spatial regions by means of the at least one separating device.

In particular, the treatment system can comprise a plurality of separating devices, for example a plurality of separating devices according to the invention.

The treatment system preferably has one or more of the features and/or advantages described in connection with the separating device.

The other spatial region can be a further treatment space portion of the treatment space.

Alternatively, the other spatial region can be a spatial portion of a device different from the treatment system.

Furthermore, the other spatial region can alternatively be surroundings of the treatment system.

It may be favorable for the treatment system to comprise a conveyor device for conveying the workpieces, which conveyor device extends in particular through the separating device in a conveying direction of the conveyor device.

The separating plane of the separating device is oriented in particular obliquely, for example perpendicularly, to the conveyor device.

It may be favorable for the conveyor device to be an indexing conveyor device.

The separating plane preferably extends between two immediately adjacent positions or locations at which workpieces to be treated remain at least temporarily, for example due to indexed conveying.

In one step of a conveyor device designed as an indexing conveyor device, a workpiece is preferably conveyed from one indexing location (position, location) arranged in one of the spatial regions to a subsequent indexing location (position, location) arranged in the other spatial region.

In one embodiment of the invention, a lower face of one or more or all of the guide elements can be at least partially or at least approximately complementary to a conveying contour of the workpieces to be conveyed by means of the conveyor device.

In particular, a lower face of one or more or all of the guide elements is at least partially and/or at least approximately complementary to an upper face of a spatial region through which the workpieces travel when conveyed in the conveying direction.

The supply device of the separating device, in particular one or more or all of the guide elements, are preferably adapted to a workpiece contour.

For example, if the treatment system is used to treat vehicle bodies, a lower face of one or more or all of the guide elements can have a region arranged further up in the vertical direction that is shaped like a roof region of the vehicle body, whereas a region of the lower face of one or more or all of the guide elements arranged further down in the vertical direction is shaped like a front hood region. Furthermore, an intermediate region of the lower face of one or more or all of the guide elements that is oriented obliquely to the vertical direction and interconnects the region arranged further up and the region arranged further down can be provided, which intermediate region is shaped like a windshield region of the vehicle body.

In one embodiment of the invention, the treatment system comprises a plurality of treatment space modules.

Each treatment space module preferably surrounds a treatment space portion and/or forms an indexing location of an indexing conveyor device.

The separating device is arranged, for example, between two treatment space modules or integrated between two treatment space modules.

One or both treatment space modules adjoining a separating device preferably have no suction for a circulation device. As a result, flow guidance can preferably be optimized in favor of a separating fluid flow.

In particular, a separating fluid curtain, for example air curtain, can be produced in a substantially vertical direction, in particular while minimizing transverse flow of a circulating air flow that reduces the separating effect.

The present invention also relates to a method for separating two spatial regions by means of a separating device.

The problem addressed by the invention in this respect is that of providing a method which is easy to carry out and provides for efficient fluid separation.

According to the invention, this problem is solved by the features of the independent method claim.

The method for separating two spatial regions by means of a separating device is in particular a method for separating two spatial regions by means of a separating device according to the invention.

In the method for separating two spatial regions, a separating fluid is preferably introduced between the two spatial regions by means of a supply device.

The separating fluid is preferably guided by means of at least two guide elements.

The at least two guide elements are preferably designed as guide plates.

It may be favorable for the at least two guide elements to be arranged at least approximately in parallel with one another and/or at least approximately vertically to one another.

The method according to the invention for separating two spatial regions is particularly suitable for use in a method for treating workpieces.

The present invention therefore also relates to a method for treating workpieces, in particular for drying coated vehicle bodies.

The method for treating workpieces preferably comprises the following: guiding workpieces through a separating device for separating two spatial regions; separating the spatial regions by supplying a separating fluid flow between the two spatial regions, in particular by carrying out the method according to the invention for separating two spatial regions.

One or more of the methods described preferably have one or more of the features and/or advantages described in connection with the separating device according to the invention and/or the treatment system according to the invention.

Furthermore, the separating device, the treatment system and/or one or more of the methods described preferably have one or more of the features and/or advantages described below:

The separating device can, for example, form an entrance lock/inlet lock or exit lock/outlet lock of any system, for example a treatment system.

Furthermore, the separating device can form an intermediate lock within a treatment system or between two treatment systems.

The formation of a flow roller is preferably prevented or at least minimized by means of the separating device. The separating effect of the separating device preferably results, at least for the most part, from a separating fluid curtain produced by means of the supply device.

The separating fluid is supplied to one or more or all of the guide elements, in particular in a region between two guide elements, preferably via a mouth portion, which is for example funnel-shaped, and which is arranged in particular in a ceiling region, for example on a ceiling wall.

Via the mouth portion, a guide channel formed between the two guide elements, for example, is in fluid communication preferably with a pressure space, which is formed, for example, in a pressure space chamber above one or both spatial regions.

Such a pressure space chamber can, for example, be provided with one or more filter elements and/or one or more fans in order to clean and/or drive the separating fluid before it is supplied between the two spatial regions.

The mouth portion preferably extends at least approximately over the entire width of the at least two guide elements and/or the passage opening.

The temperature of the separating fluid is preferably greater than the temperature of the fluids in one or both spatial regions.

The separating device separates, for example, two spatial regions in which different temperatures prevail, in particular average gas temperatures and/or average room temperatures.

In one embodiment, the separating device can follow a colder spatial region in or counter to the conveying direction. Furthermore, a warmer spatial region can follow the separating device in or counter to the conveying direction.

The statements “colder spatial region” and “warmer spatial region” are made with reference to one another, i.e., the temperature in the colder spatial region is lower than the temperature in the warmer spatial region.

In particular, in order to at least partially compensate for colder gas from the colder spatial region being mixed into the separating fluid and/or in the warmer spatial region, the separating fluid can be supplied at an increased temperature by comparison with the temperature in the warmer spatial region and/or by comparison with the temperature in the colder spatial region.

Alternatively, the separating fluid can be supplied at a reduced temperature by comparison with the temperature in the warmer spatial region and/or by comparison with the temperature in the colder spatial region. In this way, in particular, the colder spatial region can be prevented from overheating if warmer gas flows from the warmer spatial region into the colder spatial region.

It may be favorable for at least one blocking element to be arranged in the colder spatial region.

It may also be favorable for at least one outlet opening, in particular at least one suction slot, to be arranged in the warmer spatial region.

It may be advantageous for the temperature of the separating fluid to be between a temperature, in particular an average room temperature and/or average gas temperature, in the warmer spatial region and a temperature, in particular an average room temperature and/or average gas temperature, in the colder spatial region, in particular before and/or while the separating fluid is flowing between the two spatial regions.

In particular, it may be favorable for the separating device to separate two spatial regions in which different temperatures prevail, it being possible to supply the separating fluid by means of the supply device at a temperature which is between the temperature in a warmer of the two spatial regions and the temperature in a colder of the two spatial regions.

In particular, in order to vary the temperature of the separating fluid, an inlet air flow, for example a gas flow that is unconditioned at least in terms of temperature, for example a fresh air flow, can be supplied to the separating fluid, in particular can be mixed therein upstream and/or in the supply device. The inlet air flow is, for example, a bypass flow, which is guided or can be guided past a fresh air heat exchanger.

It may be favorable for the separating fluid to be provided as a hot separating fluid and then divided between at least two different separating devices, the separating fluid in one of the separating devices, in particular in precisely one of the separating devices, being cooled by mixing in a fluid, preferably the inlet air flow, optionally within the supply device and/or between the at least two guide elements.

The separating device in which separating fluid cooled by the inlet air flow is supplied is, for example, an entrance lock/inlet lock, an intermediate lock or an exit lock/outlet lock.

In one embodiment of the invention, a gas flow, for example a circulating air flow, which is directed in the one or more spatial regions by means of one or more inlet openings arranged immediately adjacently to a separating device, can deviate from the gas flow directed through other inlet openings, optionally all other inlet openings, in terms of its mass flow and/or its volume flow, in terms of a flow velocity of the gas flow and/or the temperature thereof. A controller, for example, can be provided for this purpose, which is designed and set up to carry out one or more method features and/or by means of which the deviations can be controlled and/or regulated, for example using valve devices, flap devices and/or control devices. One or more throttle plates that can be operated mechanically and/or manually or automatically can easily be provided for this purpose.

It may be favorable for one or more inlet openings arranged immediately adjacently to a separating device to comprise at least one valve device and/or flap device and/or control device or for at least one valve device and/or flap device and/or control device to be assigned to one or more inlet openings arranged immediately adjacently to a separating device.

Furthermore, it may be favorable for all of the inlet openings of a spatial region, in particular a treatment space portion, arranged immediately adjacently to a separating device to comprise at least one valve device and/or flap device and/or control device or for at least one valve device and/or flap device and/or control device to be assigned to all of the inlet openings of a spatial region, in particular a treatment space portion, arranged immediately adjacently to a separating device.

By means of at least one valve device and/or flap device and/or control device, the flow velocity and/or momentum of a gas flow supplied through one or more inlet openings in the immediate vicinity of the separating device is preferably reduced in order to influence a separating fluid flow in the separating device as little as possible.

By means of one or more flap devices and/or valve devices and/or control devices, an opening cross section of an inlet opening and/or an inflow cross section at a filter device can be in particular directly influenced.

For example, a reduced mass flow and/or volume flow can be provided for inlet openings arranged closer to the separating device.

The supply device is preferably designed to be self-regulating, in particular in order to achieve as uniform an air flow as possible in the separating plane of the separating device. In particular, adapting the guide elements to the workpiece contour results in a flow path that varies across the width of the guide elements, in particular with regard to an unguided flow path, portions with a shorter guided flow path between the guide elements resulting in an overall lower flow resistance such that, despite unguided path routes of different lengths for the separating fluid along the separating plane, a preferably at least approximately uniform separating fluid flow can be obtained. In particular, a uniform separating fluid curtain can be produced in this way.

Further preferred features and/or advantages of the invention are found in the following description and the drawings illustrating one embodiment.

### BRIEF DESCRIPTION OF THE DRAWINGS

FIG. 1 is a schematic perspective view of two treatment space modules of a treatment system, between which a separating device is arranged;

FIG. 2 is a further schematic perspective view of the treatment space modules together with the separating device from FIG. 1;

FIG. 3 is a third schematic perspective view of the treatment space modules together with the separating device from FIG. 1;

FIG. 4 is a schematic vertical cross section through one of the treatment space modules from FIG. 1 viewed in a conveying direction of a conveyor device of the treatment system;

FIG. 5 is a schematic vertical cross section through the separating device from FIG. 1;

FIG. 6 is a schematic vertical longitudinal section through the treatment space modules and the separating device from FIG. 1;

FIG. 7 is an enlarged view of region VII in FIG. 6; and

FIG. 8 is an enlarged view of region VIII in FIG. 6.

The same or functionally equivalent elements are provided with the same reference signs in all figures.

### DETAILED DESCRIPTION OF THE DRAWINGS

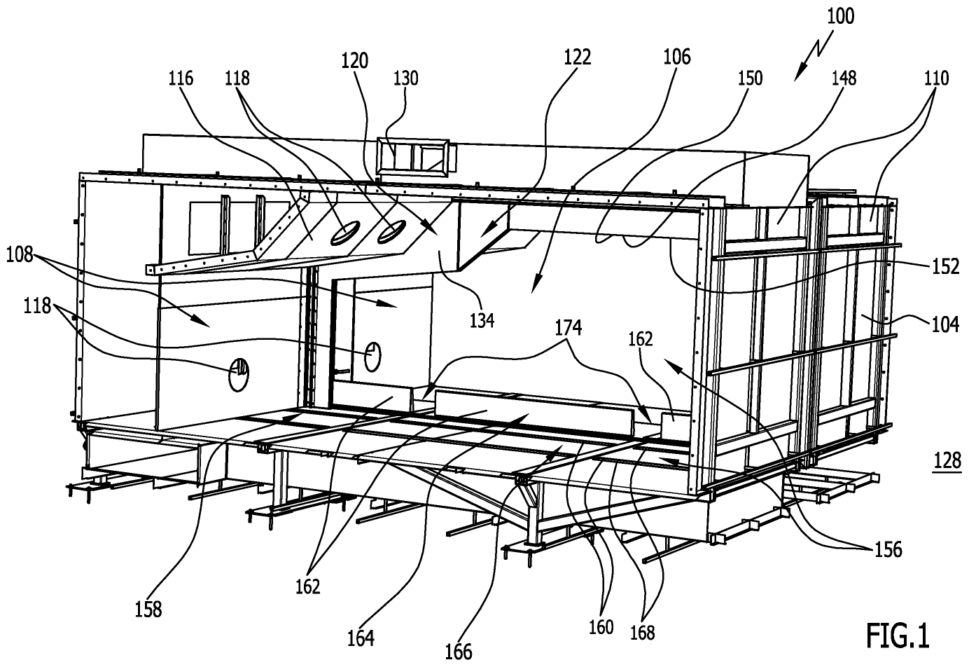

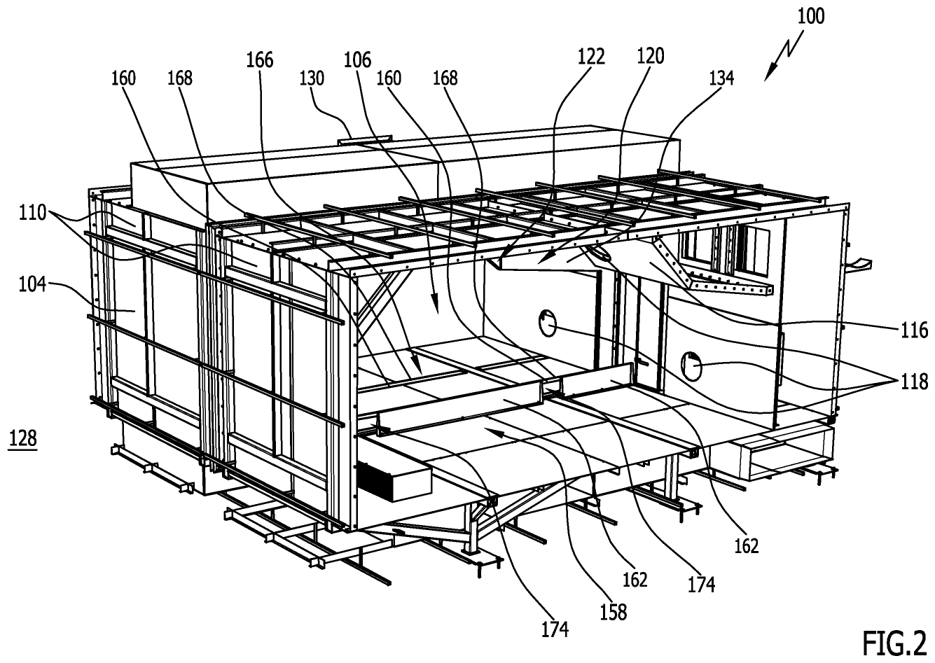

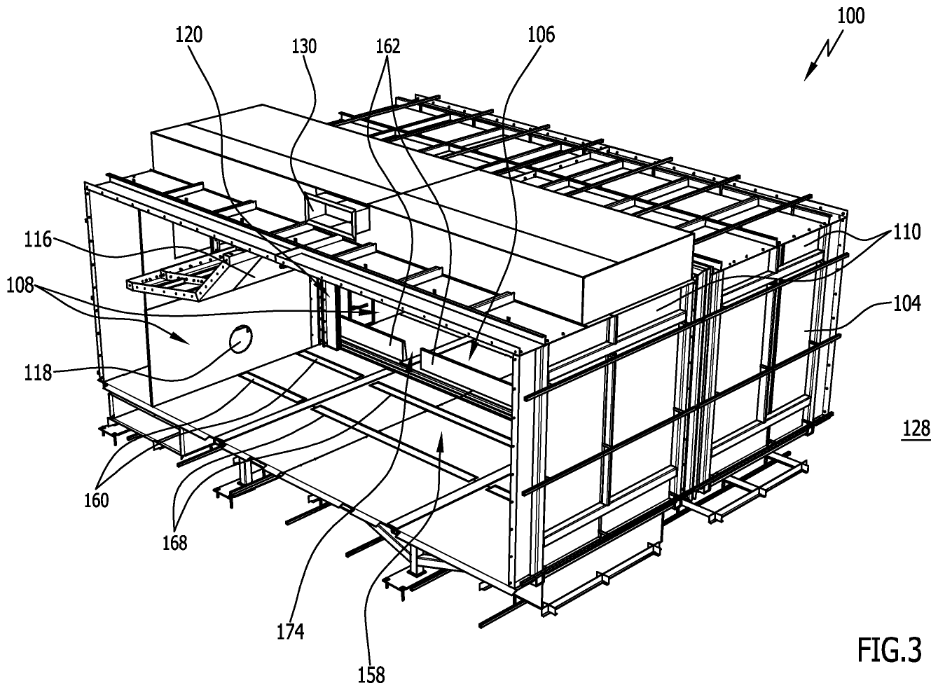

A treatment system shown in FIGS. 1 to 8, denoted as a whole by 100, is used, for example, to treat workpieces 102.

The workpieces 102 are in particular vehicle bodies dried using the treatment system 100.

In particular, the treatment system 100 is a painting system and/or a drying system.

The treatment system 100 comprises in particular a housing 104 which surrounds a treatment space 106.

The treatment space 106 comprises in particular a plurality of treatment space portions 108.

The treatment system 100 preferably comprises a plurality of treatment space modules 110, each treatment space module 110 preferably surrounding a treatment space portion 108 of the treatment space 106.

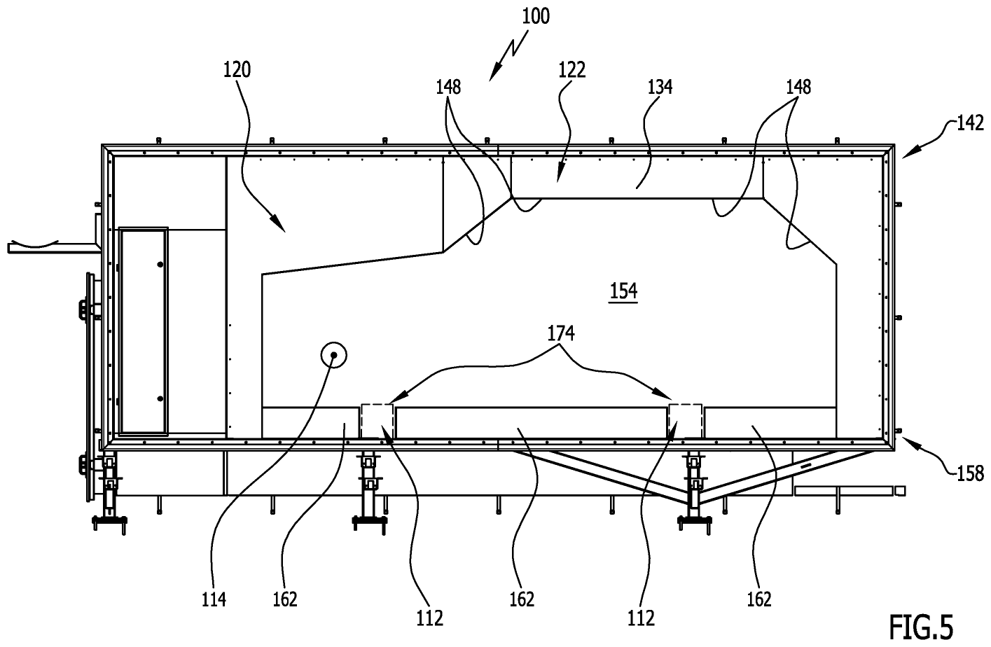

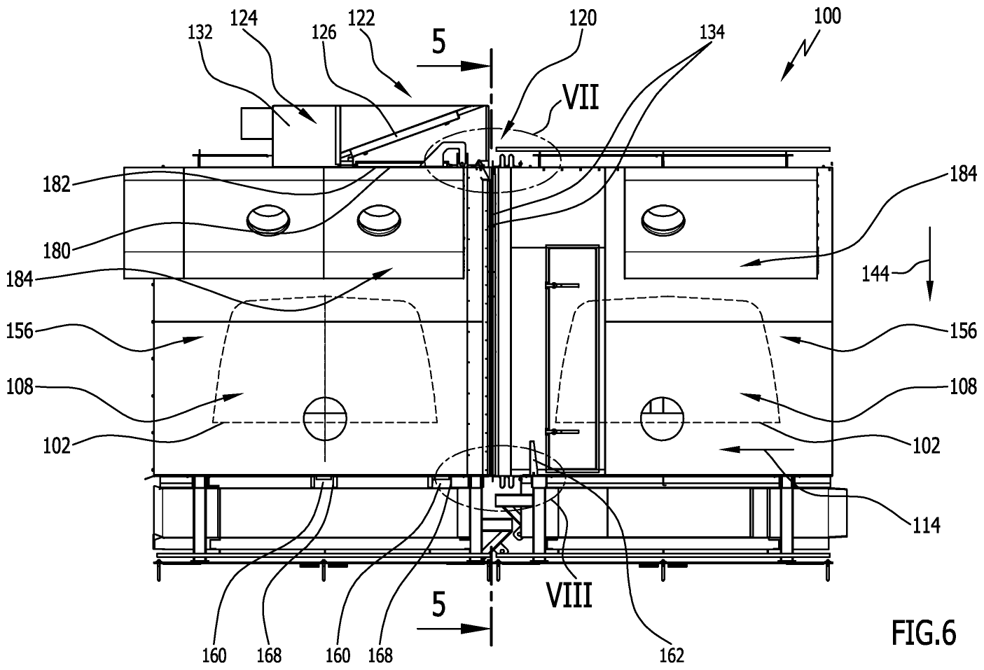

The treatment system 100 also preferably comprises a conveyor device 112, by means of which the workpieces 102 can be guided through the treatment space 106 in a conveying direction 114 (see in particular FIGS. 5 and 6).

One or more treatment space modules 110 preferably comprise a circulating air duct 116, in particular a circulating air duct 116 for each module.

Each circulating air duct 116 preferably comprises one or more inlet openings 118 for supplying a circulating air flow to the relevant treatment space portion 108.

Optionally, each circulating air duct 116 can also have one or more outlet openings in order to be able to discharge, in particular extract by suction, circulating air from the relevant treatment space portion 108.

By means of the at least one circulating air duct 116, a circulating air flow within the relevant treatment space portion 108 that is oriented substantially transversely, for example at least approximately perpendicularly, to the conveying direction 114 can be in particular produced.

In the embodiment of a treatment system 100 shown in FIGS. 1 to 8, a separating device 120 is preferably provided by means of which the two treatment space portions 108 of the two treatment space modules 110 can be separated, preferably fluidically.

In particular, fluid exchange, in particular exchange of air, between the two treatment space portions 108 can preferably be prevented or at least reduced by means of the separating device 120.

For this purpose, the separating device 120 is preferably arranged between the two treatment space modules 110 or is arranged or integrated in an end region of a second treatment space module 110 that faces a first treatment space module 110.

The separating device 120 comprises in particular a supply device 122 for supplying a separating fluid flow, for example an air flow.

For this purpose, the supply device 122 comprises in particular a fan 124 for driving the separating fluid flow and optionally one or more conditioning units for heating, cooling, extracting moisture from and/or adding moisture to the separating fluid flow and/or one or more filter elements 126 for removing contaminants from the separating fluid flow.

The separating fluid flow is, in particular, an air flow, for example from surroundings 128 of the separating device 120 and/or of the treatment system 100.

By means of a suction device 130, the separating fluid flow is preferably suctioned and supplied to one or more guide elements 134 of the supply device 122 via a pressure space chamber 132 of the supply device 122.

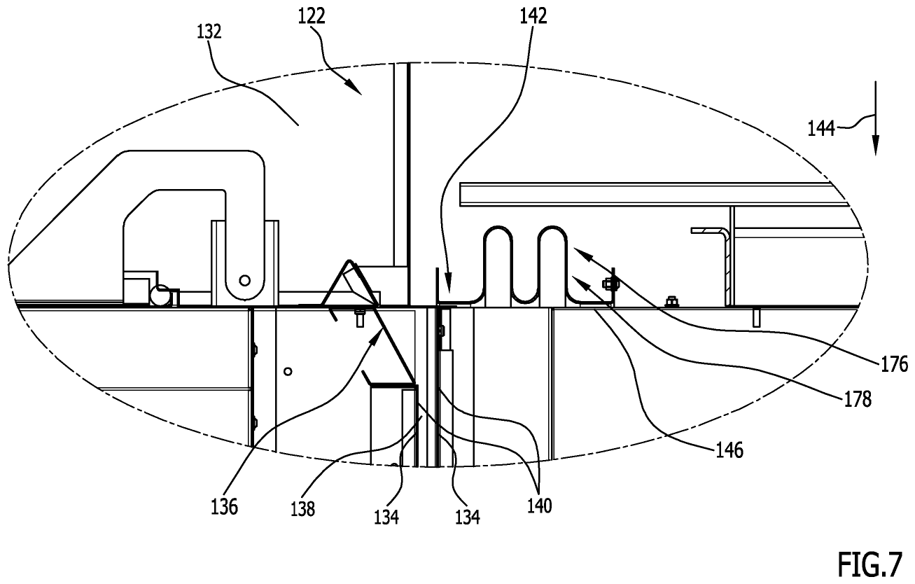

As can be seen in particular from FIGS. 6 and 7, the pressure space chamber 132 is fluidically connected by means of a mouth portion 136 to a guide channel 138 formed between two guide elements 134, and therefore separating fluid from the pressure space chamber 132 can be introduced between the two guide elements 134.

The mouth portion 136 is preferably arranged and/or formed substantially in a V shape in a cross section and/or longitudinal section.

By means of the mouth portion 136, a uniform supply of the separating fluid to the guide channel 138 is in particular made possible.

The guide elements 134 are preferably designed as guide plates 140.

The guide elements 134 are preferably arranged substantially in parallel with one another and/or extend downward, starting from a ceiling region 142, at least approximately in parallel with the direction of gravity 144.

In particular, the guide elements 134 can be arranged, in particular fixed, on a ceiling wall 146 of one or both treatment space modules 110 of the treatment system 100.

The guide elements 134 are in particular arranged and/or designed so as to be rigid and/or immovable.

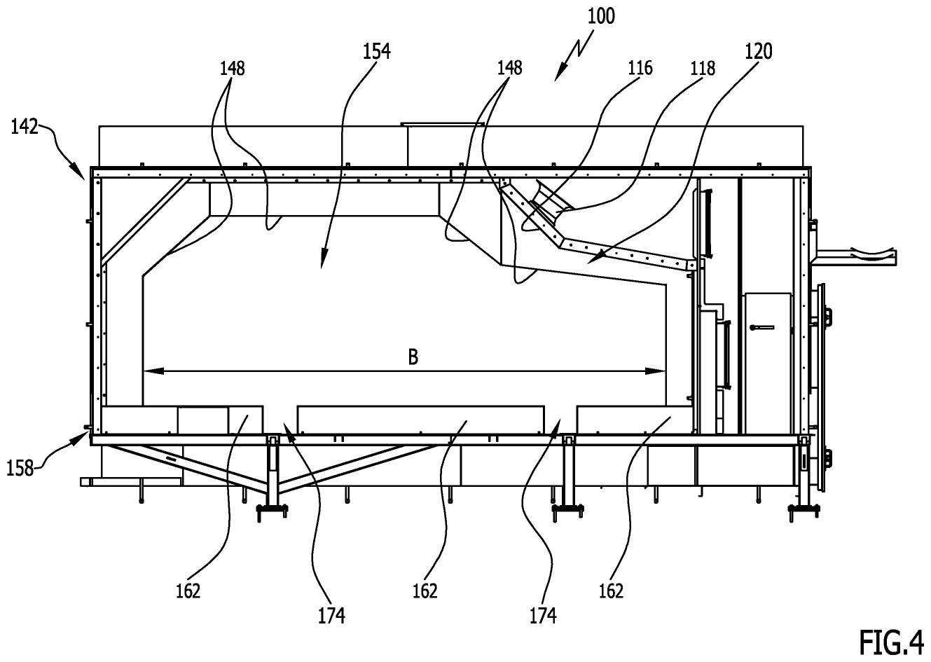

As can be seen in particular from FIGS. 1 and 4, a supply opening 148 of the supply device 122 is formed by means of the guide elements 134.

The supply opening 148 is in particular a supply slot 150 which is arranged and/or formed in particular on a lower face 152 of the guide elements 134.

The lower face 152 is in particular an end of the guide elements 134 that faces away from the ceiling region 142.

In particular, a lower face 152 of the guide elements 134 is a lower end of the guide elements 134 with respect to the direction of gravity 144.

As can be seen in particular from FIG. 4, the supply opening 148 preferably extends at least approximately over the entire width B of a passage opening 154 which interconnects the spatial regions 156, in particular the treatment space portions 108, to be separated by means of the separating device 120.

The guide elements 134 preferably have a shape which is at least approximately complementary to an outer contour of a workpiece 102 to be treated.

In particular, the lower face 152 of the guide elements 134 is adapted so as to be at least approximately complementary to an upper face of an outer contour of a workpiece 102 to be conveyed through the separating device 120.

The guide elements 134 can thus in particular form a diaphragm which reduces the passage opening 154 at least approximately to the shape and/or cross section required for conveying the workpieces 102 through the separating device 120.

By means of the supply device 120, in particular a separating fluid flow can be introduced in the direction of gravity 144 from top to bottom between the two spatial regions 156, in particular the two treatment space portions 108.

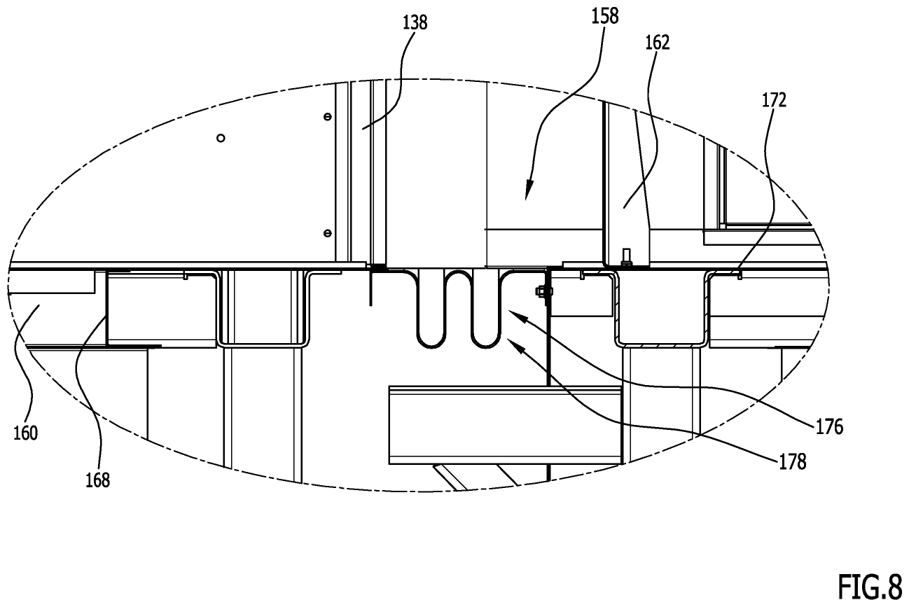

As can be seen in particular from FIGS. 6 and 8, a discharge opening to which there is a flow directly from the supply device 122 flows is not arranged and/or formed in a floor region 158 of the separating device 120 that is opposite the ceiling region 142.

Instead, a combination of one or more outlet openings 160 and one or more blocking elements 162 of a blocking device 164 is preferably provided.

A discharge device 166, which in particular comprises the one or more outlet openings 160, is preferably not arranged as a direct extension of the guide elements 134, but is instead offset in the conveying direction 114.

In particular, the two outlet openings 160 are designed as continuous and/or discontinuous suction slots 168, which extend at least approximately in parallel with a separating plane 170 of the separating device 120 in particular in the floor region 158.

The separating plane 170 is, in particular, a mirror plane of the guide elements 134 and/or a center plane of the guide channel 138.

In particular, the separating plane 170 is formed at least approximately perpendicularly to the conveying direction 114.

The separating plane 170 can also be a plane arranged and/or extending between the two treatment space modules 110.

All of the outlet openings 160 of the discharge device 166 are preferably arranged on one side of the separating plane 170.

One or more blocking elements 162 of the blocking device 164 are preferably arranged on another side of the separating plane 170 that is opposite the aforementioned side.

As can be seen in particular from FIG. 6, the blocking elements 162 extend upward, starting from the floor region 158, in particular a floor wall 172, in particular upward counter to the direction of gravity 144.

The one or more blocking elements 162 in particular provide for a damming effect such that separating fluid which is guided from top to bottom in the direction of gravity 144 by means of the guide elements 134 and which is deflected in the floor region 158 is blocked at least in a direction parallel to the conveying direction 114. In the embodiment of the treatment system 100 shown in FIGS. 1 to 8, the one or more blocking elements 162 in particular result in the separating fluid in the floor region 158 spreading counter to the conveying direction 114 and, as a result, there being no flow roller formed, for example.

By means of the one or more outlet openings 160, which are arranged on a side of the separating plane 170 that is opposite the one or more blocking elements 162, the separating fluid can preferably also be extracted by suction without a flow roller forming.

A separating fluid curtain, in particular an air curtain, produced by means of the separating fluid thereby preferably has a particularly small extent in the conveying direction 114, and so the separating device 120 can take up little installation space overall.

As can be seen in particular from FIGS. 1, 2 and 5, a plurality of blocking elements 162 or at least one or more discontinuous blocking elements 162 are preferably provided, one or more elements of the conveyor device 112, for example rails or the like, being passed through one or more gaps 174.

Furthermore, in particular with view of FIGS. 6, 7 and 8, the option of a compensation device 176 should be noted.

The compensation device 176 can in particular compensate for a temperature-related length variation of the treatment space modules 110 in the conveying direction 114.

For this purpose, the compensation device 176 preferably comprises one or more compensation elements 178, which are designed, for example, as bent, curved, and/or meandering connecting elements between the two treatment space modules 110 and/or between a treatment space module 110 and the separating device 120.

With regard to the supply device 122, it should also be noted that in particular the pressure space chamber 132, fan 124, one or more conditioning units and/or one or more filter elements 126 can be arranged in a ceiling region 142, in particular on a ceiling wall 146.

One or more filter elements 126, one or more conditioning units and/or an interior of the pressure space chamber 132 are preferably accessible from a treatment space portion 108 by means of an access element 180, for example an access flap 182. In this way, the supply device 122, in particular the one or more filter elements 126, can be maintained in a simple and cost-effective manner.

As indicated in FIG. 6, a plurality of workpieces 102 are preferably arranged in the treatment space 106 at any one time.

The conveyor device 112 is, for example, a continuous conveyor device 112.

In contrast, an indexing conveyor device is preferably provided as the conveyor device 112.

The workpieces 102 can in particular be conveyed in stepwise operation from one indexing location 184 to a subsequent indexing location 184 by means of the conveyor device 112.

The separating device 120 and the conveyor device 112 are arranged and designed in particular in such a way that the separating device 120 is arranged between two indexing locations 148.

In particular, the separating plane 170 extends between two indexing locations 184 in order to be able to produce a separating fluid curtain, in particular an air curtain, that is as continuous as possible while the workpieces 102 are at a temporary standstill. As a result, the two spatial regions 156, in particular the treatment space portions 108, can be fluidically separated.

By using the guide elements 134, the blocking device 164 and/or the discharge device 166, the separating device 120 can preferably be particularly compact, such that loss of space between the indexing locations 184 caused by the separating device 120 can be minimized as much as possible.

1. Separating device for separating two spatial regions, wherein the separating device comprises a supply device for supplying a separating fluid to be introduced between the two spatial regions, wherein the supply device preferably comprises at least two guide elements for guiding the separating fluid, which guide elements are designed in particular as guide plates.

2. Separating device according to claim 1, wherein the guide elements are arranged at least approximately in parallel with one another and/or at least approximately vertically.

3. Separating device according to claim 1, wherein the guide elements extend downward, from a ceiling region of one of the spatial regions or of both of the spatial regions.

4. Separating device according to claim 1, wherein the guide elements extend over at least approximately 70%, preferably at least approximately 90%, of a width of a passage opening interconnecting the two spatial regions.

5. Separating device according to claim 1, wherein the separating fluid can be introduced between the two spatial regions only between the two guide elements.

6. Separating device according to claim 1, wherein the separating device comprises a blocking device for blocking the separating fluid, the blocking device comprising one or more blocking elements which prevent or at least reduce the spreading of a separating fluid flow into at least one of the two spatial regions one or more blocking elements preferably being arranged in a floor region of the separating device.

7. Separating device according to claim 1, wherein the separating device comprises a discharge device for discharging the separating fluid, the discharge device being arranged in particular in a floor region of the separating device.

8. Separating device according to claim 7, wherein the discharge device comprises one or more suction slots which in particular extend partially or at least approximately completely along a plane which is offset in the parallel direction from a separating plane of the separating device.

9. Separating device according to claim 7, wherein the discharge device, in particular one or more outlet openings, for example one or more suction slots, and one or more blocking elements of a blocking device of the separating device are arranged on opposite sides of a separating plane.

10. Separating device according to claim 1, wherein the separating device separates two spatial regions in which different temperatures prevail, it being possible to supply the separating fluid by means of the supply device at a temperature which is between the temperature in a warmer of the two spatial regions and the temperature in a colder of the two spatial regions.

11. Separating device according to claim 1, wherein the separating fluid can be cooled by means of the supply device before being supplied, preferably by mixing in unconditioned fresh air.

12. Treatment system for treating workpieces, in particular a drying system for drying coated vehicle bodies, the treatment system comprising:
a treatment space for treating workpieces, which comprises one or more treatment space portions; and
at least one separating device according to claim 1, wherein at least one treatment space portion forms one of the spatial regions which can be separated from another of the spatial regions by means of the at least one separating device.

13. Treatment system according to claim 12, wherein the other spatial region is:
a) a further treatment space portion of the treatment space;
b) a spatial portion of a device different from the treatment system; or
c) surroundings of the treatment system.

14. Treatment system according to claim 12, wherein the treatment system comprises a conveyor device for conveying the workpieces, which conveyor device extends through the separating device in a conveying direction of the conveyor device.

15. Treatment system according to claim 14, wherein the conveyor device is an indexing conveyor device, and in that the separating device is arranged between two indexing locations for the workpieces.

16. Treatment system according to claim 12, wherein a lower face of the guide elements is at least partially and/or at least approximately complementary to a conveying contour of the workpieces to be conveyed by means of the conveyor device.

17. Treatment system according to claim 12, wherein the treatment system comprises a plurality of treatment space modules, each treatment space module surrounding a treatment space portion and the separating device being arranged between two treatment space modules or integrated between two treatment space modules.

18. Method for separating two spatial regions by means of a separating device, in particular a separating device according to claim 1, a separating fluid being introduced between the two spatial regions by means of a supply device, the separating fluid preferably being guided by means of at least two guide elements.

19. Method according to claim 18, characterized in that wherein the at least two guide elements are designed as guide plates and/or are arranged at least approximately in parallel with one another and/or vertically.

20. Method according to claim 18, wherein the separating fluid is provided as a hot separating fluid and is then divided between at least two different and/or spatially separated separating devices, the separating fluid in one of the separating devices, optionally in precisely one of the separating devices, being cooled by mixing in a fluid, in particular a flow of fresh air that is unconditioned at least in terms of temperature, in particular within a supply device and/or between the at least two guide elements.

21. Method for treating workpieces, in particular for drying coated vehicle bodies, the method comprising:
guiding workpieces through a separating device for separating two spatial regions; and
separating the spatial regions by supplying a separating fluid flow between the two spatial regions, in particular by carrying out the method according to claim 18.
